(19) United States
(12) Patent Application Publication
(10) Pub. No.: US 2006/0025000 A1
(43) Pub. Date: Feb. 2, 2006

(54) Adapter for electrical connectors

(76) Inventor: Stefan Reker, Bielefeld (DE)

Correspondence Address: LAWRENCE E. LAUBSCHER, SR.;LAUBSCHER LAW OFFICES, 1160 SPA ROAD, SUITE 2B, ANNAPOLIS, MD, 21403, US

(21) Appl. No.: 11/179,448

(22) Filed: Jul. 12, 2005

(30) Foreign Application Priority Data
Jul. 29, 2004 (DE) 20 2004 011 880.7

(51) Int. Cl. H01R 13/52

(52) U.S. Cl. 439/281

(57) ABSTRACT

An electrical distributor assembly includes a plug member connected with a socket member that is mounted on, and extends slightly above, the top surface of a distributor housing, characterized by the provision of an axially displaceable protective sleeve mounted concentrically about the plug and socket members. The plug includes an upwardly extending integral cable supporting portion that is also enclosed by the sleeve.

### BACKGROUND OF THE INVENTION

1. Field of the Invention

An electrical distributor assembly includes a plug member connected with a socket member that is mounted on, and extends slightly above, the top surface of a distributor housing, characterized by the provision of an axially displaceable protective sleeve mounted concentrically about the plug and socket members. The plug includes an upwardly extending integral cable supporting portion that is also enclosed by the sleeve.

2. Description of the Related Art

This invention relates to a distributor arrangement for supplying electrical energy from cable conductors to the sensing and actuating components of an automated building structure, including a distributor housing that is provided with a plurality of sockets connected with various the building components, and a plurality of plugs that are connected with the supply cables, respectively.

Such arrangements are well known in the prior art, as shown, for example, by the U.S. patent to Yentile et al U.S. Pat. No. 6,174,206, and the European Published Applicaton No. 1,251,595. In general, the power supply cables are connected to the field bus subscribers by socket members that at their ends facing the distributor have a corresponding plug member. Although these arrangements generally proved to be effective as such, it was nevertheless, discovered that under extremely rough environmental conditions, a rupture often occurs of the coupling between the plug and socket members, or of the cable in the area of connection to the plug member.

Accordingly, in keeping with the present invention, there is provided a protective sleeve that is axially displaceable to concentrically enclose the coupled plug and socket members, which sleeve preferably extends over the entire axial length of the plug and socket assembly. In this manner, with a simple effort in terms of design, one can ensure a particularly stable protection for the coupling consisting of the socket and plug members mounted on the distributor housing.

### BRIEF SUMMARY OF THE INVENTION

Accordingly, a primary object of the present invention is to provide a distributor arrangement in which a socket member is mounted on the top face of a distributor housing, a plug member is mounted upon the socket member with contacts on the plug member in engagement with corresponding contacts on the socket member, and a protective sleeve is mounted concentrically about the plug and socket assembly. The inner diameter of the sleeve corresponds with the outer diameter of the socket member, whereby the sleeve is at least partially supported by its engagement with the circumferential surface of the socket member.

According to a more specific object of the invention, the socket member is supported on the distributor body by a pair of cylindrical support members. The upper first support member has a diameter that corresponds with the inner diameter of the sleeve, whereby the sleeve engages and is at least partially supported on the distributor housing by the outer circumferential surface of the upper support member. The lower support member has an outer diameter that is greater than the inner diameter of the sleeve, whereby the lower support member serves as an abutment or stop for limiting the downward movement of the sleeve relative to the plug and socket assembly. The length of the sleeve is such that when the lower end of the sleeve engages the lower support member, the upper end of the sleeve terminates opposite the upper extremity of a cable supporting portion that extends axially upwardly from the plug.

### BRIEF DESCRIPTION OF THE DRAWINGS

Other objects and advantages of the invention will become apparent from a study of the following specification when viewed in the light of the accompanying drawings, in which:

FIG. 1 is a top front perspective view of the distributor apparatus of the present invention; and

FIG. 2 is a sectional view taken along line 2-2 of FIG. 1.

### DETAILED DESCRIPTION OF THE INVENTION

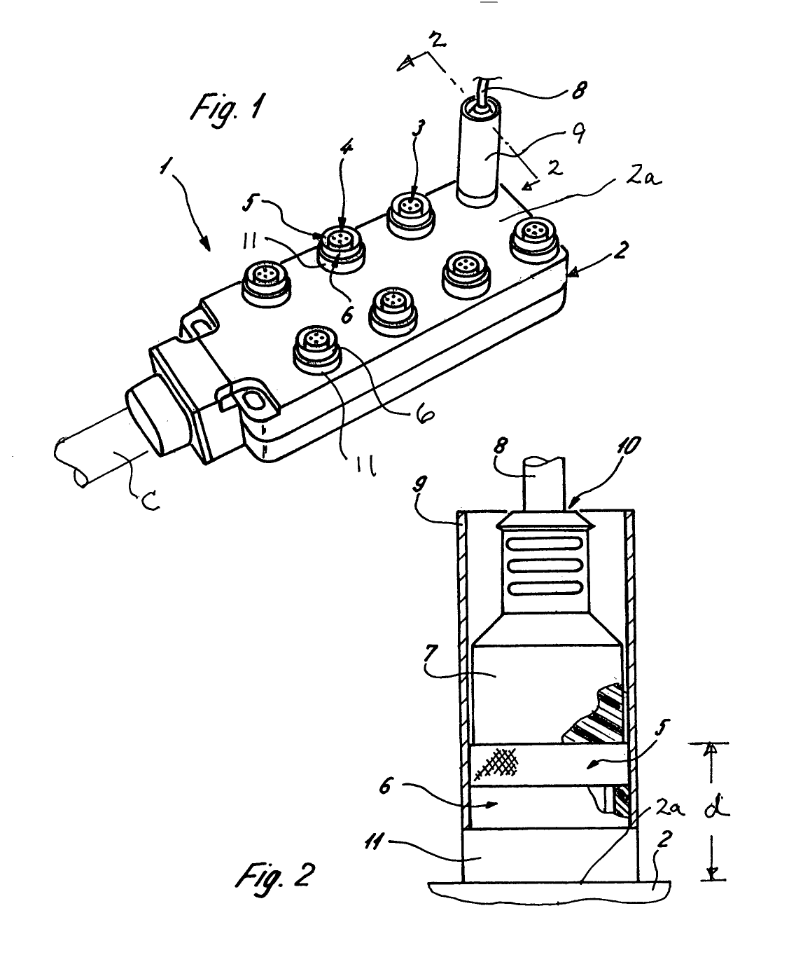

Referring first more particularly to FIG. 1, the distributor apparatus 1 includes a distributor housing 2 having a top surface 2a upon which are mounted a plurality of electrical connectors 3 and 4 having cylindrical socket members 5 that are adapted for connection with the various sensors or actuators of an automated building system via cables 8, and to the main control panel by the distributor cable means C. The connections provided by the contacts 3 and 4 are of the so-called “M-standard” type, such as M5 connections, M6 connections, M12 connections, and so forth. Each of the socket members 5 is supported a given distance d (FIG. 2) from the distributor body top surface 2a by upper first and lower second cylindrical support members 6 and 11, respectively. This distance d is on the order of several millimeters, and is preferably greater than 3 mm. As is common with the M-standard type connections, a nut (not shown) may be provided for firmly connecting the plug member 7 to the socket member 5. The socket support members 6 and 11 are preferably formed from a conventional synthetic plastic electrical insulating material.

Mounted on the socket members 5 are plug members 7 having electrical contacts that engage corresponding contacts 3 and 4 on the socket members. The contacts of each plug member are connected with the corresponding conductors of a cable 8 that extends upwardly from the plug via an axially extending integral cable supporting plug portion 10. The plug and socket members are preferably formed from a suitable electrically insulating synthetic plastic material, as is known in the art.

As best shown in FIG. 2, according to a characterizing feature of the present invention, a rigid protective sleeve 9 is provided that is axially displaceable to a position concentrically enclosing the assembled plug and socket members. More particularly, the sleeve 9, which is preferably formed of metal, has an inner diameter that corresponds with the outer diameter of the socket member 6. Thus, when the sleeve is axially displaced relative to the socket member, the sleeve will slidingly engage the outer circumferential surface of the socket member, thereby to firmly connect the two members together in a stable manner, with the sleeve being supported by the socket member. The outer diameter of the cylindrical plug member is slightly less than the inner diameter of the sleeve 9, and the plug cable supporting portion 10 has an outer diameter that is appreciably less than that of the inner diameter of the sleeve 9. The lower support member 11 has a diameter that is greater than the inner diameter of the sleeve 9, whereby when the sleeve is mounted to protectively enclose the connected plug and socket members, the lower end of the sleeve abuts and is seated on the upper end of the lower support member 11. The length of the sleeve is such that the upper end of the sleeve 9 terminates precisely adjacent the upper extremity of the cable supporting portion 10 of the plug member. In this manner, nicking of the cable outer insulation layer by the protective sleeve 9 is avoided.

While in accordance with the provisions of the patent Statutes the preferred forms and embodiments of the invention have been illustrated and described, it will be apparent to those skilled in the art that various changes may be made without deviating from the inventive concepts set forth above.

What is claimed is:

1. Distributor apparatus for connecting the conductors of an electrical power supply system to the components of an automated building structure or the like, comprising:
(a) a distributor housing (2) having a top surface (2a);
(b) a socket member (5) having a plurality of first electrical contacts adapted for connection with the building components;
(c) support means (6,11) supporting said socket member on said distributor body top surface;
(d) a plug member (7) mounted on said socket member, said plug member having a plurality of second electrical contacts arranged for engagement with said first electrical contacts, respectively;
(e) a cable (8) extending from said plug and including a plurality of conductors connected with said second contacts, respectively; and
(f) a protective sleeve (9) removably mounted concentrically around said plug member and said socket member.

2. Distributor apparatus as defined in claim 1, wherein said protective sleeve has a length that is at least as great as the total length of said plug and socket members.

3. Distributor apparatus as defined in claim 1, wherein each of said plug and sockets members is cylindrical; wherein said sleeve member is tubular; and further wherein said support means includes a cylindrical first support member (6) having an outer diameter corresponding with the internal diameter of said protective sleeve, said protective sleeve extending concentrically about and being mounted for axial sliding displacement relative to the outer circumference of said first support member.

4. Distributor apparatus as defined in claim 3, wherein the outer diameter of said socket member corresponds generally with the internal diameter of said protective sleeve, said protective sleeve being in sliding engagement with the outer circumferential surface of said socket member.

5. Distributor apparatus as defined in claim 4, wherein the outer diameter of said plug member is less than the inner diameter of said sleeve.

6. Distributor apparatus as defined in claim 4, wherein said support means includes a second cylindrical support member (11) having an outer diameter that is greater than the internal diameter of said protective sleeve, said protective sleeve having a first end in abutting seated engagement with said second cylindrical support member.

7. Distributor apparatus as defined in claim 6, wherein said plug member includes at one end remote from said socket member an axially extending cable supporting portion (10) having a reduced outer diameter and terminating at a free extremity, said sleeve having a second end portion that terminates opposite said free extremity of said cable supporting plug portion.

8. Distributor apparatus as defined in claim 1, wherein said socket includes an end surface adjacent said plug that is spaced by a distance (d) of at least 3 mm from said distributor body top surface.

9. Distributor apparatus as defined in claim 1, wherein said sleeve is formed from metal.
